(19) United States
(12) Patent Application Publication
(10) Pub. No.: US 2012/0166539 A1
(43) Pub. Date: Jun. 28, 2012

(54) SHARED COMMUNICATION SYSTEM FOR A PLURALITY OF AUTOMATION SYSTEMS OF A DIFFERENT KIND IN AN AUTOMATION-ORIENTED COMPLEX

(75) Inventors: Alfred DOTSCHKAL, Petershagen (DE); Klemens Gildner, Minden (DE)

(73) Assignee: ABB Technology AG, Zurich (CH)

(21) Appl. No.: 13/336,212

(22) Filed: Dec. 23, 2011

(30) Foreign Application Priority Data
Dec. 23, 2010 (DE) 102010056078.2

(51) Int. Cl. G06F 15/16

(52) U.S. Cl. 709/204

(57) ABSTRACT

A shared communication system is provided for a plurality of standardized control systems and at least one gateway having different kinds of communication protocols in an automation-oriented installation. Each of the different kinds of control systems and the at least one gateway has a respective communication interface based on the same global signal transmission protocol for the purpose of connection to a shared communication network, which sets up information interchange between the different kinds of standardized control systems and the at least one gateway beyond the system boundaries of the control systems.

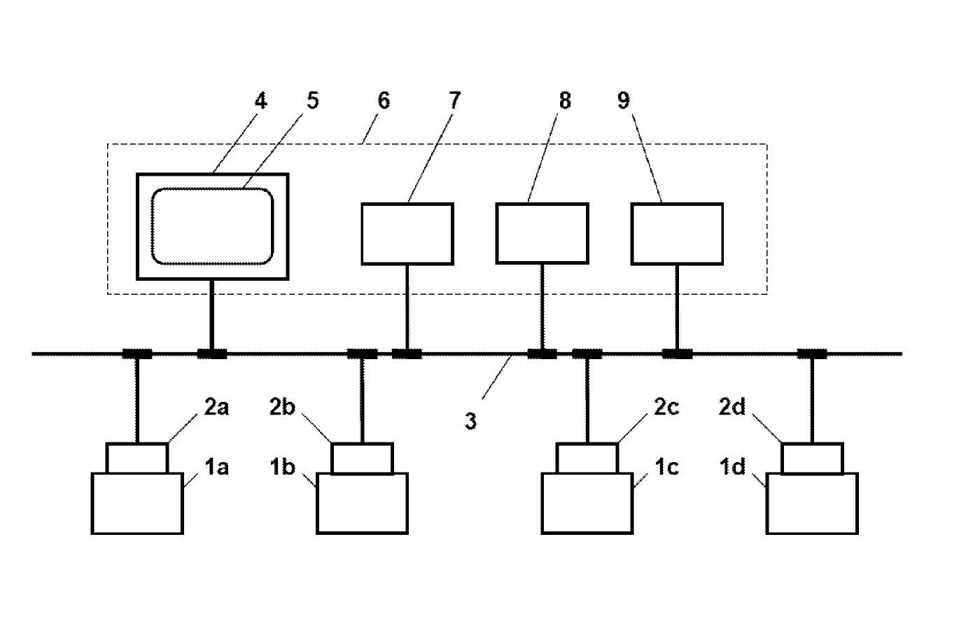

### RELATED APPLICATION

This application claims priority under 35 U.S.C. §119 to German Patent Application No. 102010056078.2 filed in Germany on Dec. 23, 2010, the entire content of which is hereby incorporated by reference in its entirety.

### FIELD

The present disclosure relates to a shared communication system for a plurality of standardized control systems having different kinds of communication protocols in an automation-oriented installation. Furthermore, the present disclosure relates to an automation-oriented installation itself which is equipped with such a shared communication system for the implemented control systems.

### BACKGROUND INFORMATION

Within the context of the present disclosure, an automation-oriented installation is understood to mean an industrial installation which includes different subsystems, which do not necessarily have to be in a locally aggregated arrangement but may also be in the form of a transnational structure. By way of example, an electrical power supply network which is fed by different kinds of relatively small and relatively large power generation units may therefore also be understood to mean such an installation. The different power generation units in this case may be windmills, communal heating and power stations as relatively small units or large power stations, for example, for covering a basic load, in the complex of the network. All of these totally different power generation units are operated by various standardized control systems which take into consideration and control a multiplicity of system parameters. Within the scope of the entire installation of the electrical power supply network, control systems such as AC 500 controllers for relatively small and medium installation sizes or else harmony or melody control systems as relatively large control systems are therefore used, which use individual communication protocols to perform their control tasks. All of these control systems work in essence but have only limited opportunities—in many case proprietary—for communicating with one another. There is therefore only a quite limited possibility of implementing automated interoperability.

Besides such grids in the complex of power-generating installations, the present disclosure can also be applied to installations in industrial automation, switchgear, building automation and process control engineering in process-oriented installations and the like.

DE 197 39 297 A1 discloses a shared communication system for an automation installation, in which the communication system is used for transparency in the superordinate communication between two grids. In this case, a first physical network is available in which all connected devices can communicate on the basis of a first communication protocol.

Furthermore, at least one second physical network, connected to the first network via a first control device, is provided in which all devices connected thereto can communicate on the basis of a second communication protocol.

The first and second networks and the first and second communication protocols are different. Each first control device has a logical interface which is designed for essentially transparent communication between at least one device connected to the first network and at least one device connected to the second network using the first communication protocol. In other words, the first communication protocol of the first physical network is thus used for global communication with the second network.

However, if the number of networks, which are each self-contained standardized control systems, to be brought together by this means for communication purposes increases then it is not possible under all circumstances to cover the intercommunication according to requirements using one of the communication protocols. This becomes more significant as the communication protocols of the networks, that is to say standardized control systems, which are to be united by these means becomes more diverse.

### SUMMARY

An exemplary embodiment of the present disclosure provides a shared communication system which includes a plurality of standardized control systems, at least one gateway, and a shared communication network. The plurality of standardized control systems and the at least one gateway have different kinds of communication protocols in an automation-oriented installation. Each of the different kinds of standardized control systems and the at least one gateway each have a respective communication interface based on the same global signal transmission protocol for connection to the shared communication network. The communication network is configured to set up an information interchange between the different kinds of standardized control systems and the gateway beyond system boundaries of the control systems.

An exemplary embodiment of the present disclosure provides a method for operating a communication system. The communication system includes a plurality of standardized control systems and at least one gateway having different kinds of communication protocols in an automation-oriented installation. The exemplary method includes communicating between the different kinds of control systems and the at least one gateway via a shared communication network. The exemplary method also includes setting up, by the shared communication network, an information interchange between the different kinds of standardized control systems and the gateway beyond system boundaries of the control systems, via a respective communication interface of each one of the different kinds of control systems and the at least one gateway which is based on the same global signal transmission protocol.

### BRIEF DESCRIPTION OF THE DRAWING

Additional refinements, advantages and features of the present disclosure are described in more detail below with reference to exemplary embodiments illustrated in the drawing, which illustrates a shared communication system for a plurality of standardized control systems having different kinds of communication protocols in an automation-oriented installation according to an exemplary embodiment of the present disclosure.

### DETAILED DESCRIPTION

Exemplary embodiments of the present disclosure provide a shared communication system which can be used for totally different kinds of communication protocols of individual standardized control systems in an automation-oriented installation.

Exemplary embodiments of the present disclosure provide a shared communication system for a plurality of standardized control systems and gateways having different kinds of communication protocols in an automation-oriented installation. In accordance with an exemplary embodiment, each of the different kinds of communication systems and the gateway has a communication interface based on the same global signal transmission protocol for the purpose of connection to a shared communication network which sets up an information interchange between the different kinds of standardized control systems and the gateway beyond the system boundaries of the control systems. Exemplary embodiments of the present disclosure also provide a method for operating such a communication system.

Exemplary embodiments of the present disclosure provide that each of the different kinds of control systems has a communication interface based on the same global signal transmission protocol for the purpose of connection to a shared communication network, which sets up information interchange between the different kinds of standardized control systems beyond the system boundaries of said control systems.

In other words, a standard, overlaid network with clearly defined behaviors and protocols is thus provided which allows automated interoperability, since it is capable of bringing together a multiplicity of control systems, for example in process control engineering (e.g., AC 500, AC 700, System 800xA Melody, Harmony, Contronic) and the like, industrial automation, switchgear domain, building automation, network engineering and the like. All systems work in essence on account of the individual communication protocols and, in accordance with exemplary embodiments of the present disclosure, now also have the unlimited opportunity to communicate with one another, for example, in order to interchange signals and measured values or to recognize and act upon system states, utilization levels and the like from a global location.

In this case, according to exemplary embodiments of the present disclosure, the functionality of the individual standardized control systems which work in essence are not restricted. Each control system can continue, as previously, to the automated but additionally provides the opportunity for plannable openness, as a result of which signals—such as switching commands or measurement signals—and messages—such as control commands—can be available and take effect globally beyond the system boundaries. In this context, the shared communication network which is the subject matter of the present disclosure is intended to include real-time ranking of signals, for example, measurement signals, automatic redundancy structures for the transmission and processing of the signals, automatic combined operation for setting up connections for signal rankings and channel-by-channel monitoring of the life status of the signal transmissions by a chain structure of the network, for example.

In this case, provision may be made for the combined operation to be effected periodically, under interrupt control or more or less continuously.

The communication system according to the present disclosure can be produced using standard components in automation engineering. In this case, the communication network according to the present disclosure is not limited to a local intranet, for example, but rather can also include other communication elements, such as the Internet, secure communication protocols, WLAN systems, in its network structure. It is thus possible to safely include installation complexes in a shared communication concept beyond installation and national boundaries.

In accordance with an exemplary embodiment, the global signal transmission protocol of the communication interface can define the signals using their name and supplementary information appended thereto in order to allow communication between the different kinds of control systems via what is known as a combined operation functionality. This means that the communication between the individual communication interfaces of the control systems does not require the assistance of a central computation unit which is involved in the shared communication network and which accomplishes the communication by virtue of appropriate signal transmission. On the contrary, each communication interface is equipped with intelligence (e.g., a processor of a computer processing device executing a program recorded on a non-transitory computer-readable recording medium) which can use the name and supplementary information appended thereto from a signal to filter the signals which are relevant to the individual operation out of the communication network. This renders additional engineering for the connections superfluous. If the sources and sinks of the signals have been found and connected to one another by the combined operation, it is possible, for performance reasons, for the constant measured value transmission to be effected using explicit short names derived from the combined operation.

According to an exemplary embodiment of the present disclosure, the communication network can be equipped with means for monitoring the live status of the signal states which are currently being output by the communication interfaces. In a chain structure of different communication interfaces which are based on one another and which convey signals which represent the status of an encoder, for example, it may transpire that the loss of a chain link between the signal transmitter and the signal receiver is unnoticed and therefore results in malfunctioning of the signal receiver. Binary signals, for example, may not change even over a relatively long period of time. Without such monitoring of the live status, it would not be possible to recognize whether a transmitted signal state is at all still valid. If the communication interface serving as the transmitter of a signal now fails, another communication interface serving as a receiver of such signals sometimes learns nothing about it, even if the communication still works on a section-by-section basis within the network structure.

Therefore, according to an exemplary embodiment of the present disclosure, such monitoring of the live status of a signal state can be performed by adding a time stamp to a current signal state. Instead of the receiver of the signal, the time stamp can then be evaluated such that it is possible to identify whether the signal is still live. In accordance with an exemplary embodiment, the signal has such a time stamp added to it even if the signal state has not changed. The time stamp can be characterized such that it is possible to distinguish firstly the time stamp in the event of a signal change and secondly the time stamp for the purpose of monitoring the live status, in order to be able to evaluate the time stamps on the receivers of the signals in different ways too.

So that different kinds of systems can communicate with one another in the communication network according to the present disclosure, the signals used for this purpose are made available as a kind of global variable in a known structure. By way of example, this can be achieved by virtue of the individual communication interfaces using a respectively associated graphically displayable server mask to describe their functionality and also being configurable by this means. In addition, server services such as proxies can be used for offline preconfiguration in order to reduce the configuration complexity. Such a server mask may be able to be called by means of a web browser as part of an interface board of the communication network, for example. This allows known and unknown system units to be accessed online, and the signals therefrom to be interpreted, from various engineering tools, browsers and the like using the shared communication network, without the need for system-specific adjustments to the respectively provided engineering tools. Besides their functionality, the communication interfaces thus additionally bring along their configuration masks and rules themselves. Since the configuration masks and rules—as described above—can also be used offline as proxies, offline engineering without the relevant units is likewise possible. In the case of online connection of the communication interfaces on the network, the configuration data created offline are transmitted just to the communication interfaces.

In accordance with an exemplary embodiment, the aforementioned interface board of the communication network may furthermore also include at least one display having the greatest surface area possible for the visual display of the installation using a suitable graphical layout. In addition, within the context of an interface board, it is also possible to perform installation remote control using measurement signals, switching commands and the like, and it is also possible to use the interface board to perform installation modeling by converting the hardware components, the operation software thereof and also the connections among one another using planning tools. This provides the user of the automation-oriented installation with an overview of the current states, the performance capability and the like of the entire installation from a global location.

In accordance with an exemplary embodiment of the present disclosure, the communication interface, which can be in the form of an Ethernet interface for standardized data interchange using data packets, for example, is arranged on a control unit for each of the different kinds of control systems (e.g., AC 500, M Controller, Harmony). In addition, however, it is also possible to use other suitable interfaces.

Further measures which improve the disclosure are illustrated in more detail below together with the description of exemplary embodiments with reference to the drawing. The drawing shows a schematic block diagram of an automation-oriented installation having a plurality of different standardized automation systems which are in contact with a shared communication network.

According to the drawing, the automation-oriented installation includes three different control systems 1a-1c and a gateway 1d. For example, the first control system 1a can be an AC 500, the second control system 1b can be designed on the basis of an M controller, the third control system 1c can be based on a Harmony Bridge and the gateway can be used as an interface to an extraneous automation system and/or to field bus units, input/output units, process computers or the like. Each of the different control systems 1a-1c and the gateway have a communication interface 2a-2d, respectively, which is based on the same global signal transmission protocol. The communication interfaces 2a-2d are used to set up a connection to a shared communication network 3. In this exemplary embodiment, the communication interfaces 2a-2d are in the form of Ethernet interfaces for standardized data interchange using data packets.

In accordance with an exemplary embodiment, the shared communication network 3 does not require a central computer unit for managing the communication, which, in contrast to this, is effected via a combined operation functionality by virtue of appropriate intelligence in the communication interfaces 2a-2d, which to this end are each equipped with processors (e.g., microprocessors) configured to execute a software program tangibly recorded on a non-transitory computer-readable recording medium (e.g., a non-volatile memory).

Within the scope of the shared communication network 3, a server mask 4 is provided which can be displayed on a computer by means of a web browser 5 and describes the functionality of the communication interfaces 2a-2d and also allows configuration of the communication interfaces 2a-2d by this means.

The web browser 5 with the server mask 4 is part of an interface board 6—arranged at a global location—of the communication network 3, which also includes a display 7 for the visual display of the installation by means of a graphical layout, an installation remote control 8 and a planning tool 9.

The installation remote control 8 allows the control systems 1a-1c and the gateway 1d to be controlled by means of measurement signals and switching commands. The planning tool 9 can be used to perform installation modeling of the system structure using a building block concept. In accordance with an exemplary embodiment, such modeling can be used for the visual display of the installation in the display 7.

The disclosure is not limited to the exemplary embodiment described above. On the contrary, modifications thereof are also conceivable which are also covered by the scope of protection of the subsequent claims. By way of example, it is possible for control systems of a different kind in automation engineering, such as process control engineering, industrial automation, switchgear engineering, building automation and the like, to be connected to one another by means of the shared communication system for the purpose according to the disclosure.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Control system

2 Communication interface

3 Communication network

4 Server mask

5 Web browser

6 Interface board

7 Display

8 Installation remote control

9 Planning tool

What is claimed is:

1. A shared communication system comprising:
a plurality of standardized control systems;
at least one gateway; and
a shared communication network;
wherein the plurality of standardized control systems and the at least one gateway have different kinds of communication protocols in an automation-oriented installation,
wherein each of the different kinds of standardized control systems and the at least one gateway each have a respective communication interface based on the same global signal transmission protocol for connection to the shared communication network, and
wherein the communication network is configured to set up an information interchange between the different kinds of standardized control systems and the gateway beyond system boundaries of the control systems.

2. The shared communication system as claimed in claim 1, wherein the global signal transmission protocol of each communication interface is configured to define signals in an identifiable manner using a name of the signals and supplementary information appended thereto to allow for communication between the different kinds of control systems and the gateway via a combined operation functionality.

3. The shared communication system as claimed in claim 2, wherein the global signal transmission protocol of each communication protocol is configured to effect a constant measured value transmission using explicit short names derived from the combined operation as soon as sources and sinks of the signals have been found and connected to one another by the combined operation.

4. The shared communication system as claimed in claim 2, wherein the communication network comprises means for monitoring a live status of states of the signals which are currently being output by the communication interfaces.

5. The shared communication system as claimed in claim 4, wherein the means for monitoring the live status of a signal state are configured to add a time stamp to a current signal state.

6. The shared communication system as claimed in claim 1, wherein the communication interfaces of the shared communication network are configured to describe their functionality using a respectively associated graphically displayable server mask and are configurable by means of the server mask.

7. The shared communication system as claimed in claim 6, comprising:
an interface board including a WEB browser,
wherein the server mask is configured to be called by means of the WEB browser.

8. The shared communication system as claimed in claim 7, wherein the interface board comprises at least one of:
at least one display for visual display of an installation by means of a graphical layout;
an installation remote control using measurement signals and switching commands; and
a planning tool for installation modeling.

9. The shared communication system as claimed in claim 1, wherein the communication interface comprises an Ethernet interface for standardized data interchange using data packets.

10. The shared communication system as claimed in claim 1, wherein the plurality of different kinds of control systems and the at least one gateway in the automation-oriented installation are selected from a group consisting of: process control engineering, industrial automation, switchgear engineering, building automation and power system engineering.

11. An automation-oriented installation having a plurality of different standardized control systems and gateways which are connected to a shared communication system as claimed in claim 1.

12. A method for operating a communication system, wherein the communication system includes a plurality of standardized control systems and at least one gateway having different kinds of communication protocols in an automation-oriented installation, the method comprising:
communicating between the different kinds of control systems and the at least one gateway via a shared communication network; and
setting up, by the shared communication network, an information interchange between the different kinds of standardized control systems and the gateway beyond system boundaries of the control systems, via a respective communication interface of each one of the different kinds of control systems and the at least one gateway which is based on the same global signal transmission protocol.

13. The method as claimed in claim 12, wherein measured values are transmitted constantly using explicit short names derived from a combined operation as soon as sources and sinks of the signals have been found and connected to one another by the combined operation.

14. The method as claimed in claim 12, wherein the combined operation is effected periodically.

15. The method as claimed in claim 12, wherein the combined operation is effected under interrupt control.

16. The method as claimed in claim 12, wherein the combined operation is effected substantially continuously.

17. The shared communication system as claimed in claim 3, wherein the communication network comprises means for monitoring a live status of states of the signals which are currently being output by the communication interfaces.

18. The shared communication system as claimed in claim 17, wherein the means for monitoring the live status of a signal state are configured to add a time stamp to a current signal state.

19. The shared communication system as claimed in claim 17, wherein the communication interfaces of the shared communication network are configured to describe their functionality using a respectively associated graphically displayable server mask and are configurable by means of the server mask.

20. The shared communication system as claimed in claim 19, comprising:
an interface board including a WEB browser,
wherein the server mask is configured to be called by means of the WEB browser.

21. The shared communication system as claimed in claim 20, wherein the interface board comprises at least one of:
at least one display for visual display of an installation by means of a graphical layout;
an installation remote control using measurement signals and switching commands; and
a planning tool for installation modeling.

22. The shared communication system as claimed in claim 21, wherein the communication interface comprises an Ethernet interface for standardized data interchange using data packets.

23. The shared communication system as claimed in claim 21, wherein the plurality of different kinds of control systems and the at least one gateway in the automation-oriented installation are selected from a group consisting of: process control engineering, industrial automation, switchgear engineering, building automation and power system engineering.

24. An automation-oriented installation having a plurality of different standardized control systems and gateways which are connected to a shared communication system as claimed in claim 21.

25. The method as claimed in claim 13, wherein the combined operation is effected periodically.

26. The method as claimed in claim 13, wherein the combined operation is effected under interrupt control.

27. The method as claimed in claim 13, wherein the combined operation is effected substantially continuously.

28. The method as claimed in claim 13, wherein the global signal transmission protocol of each communication interface defines signals in an identifiable manner using a name of the signals and supplementary information appended thereto to allow for communication between the different kinds of control systems and the gateway via functionality of the combined operation.
